(19) United States
(12) Patent Application Publication
(10) Pub. No.: US 2005/0024535 A1
(43) Pub. Date: Feb. 3, 2005

(54) Image display apparatus

(75) Inventors: Hiroshi Tatemori, Tokyo (JP); Masayoshi Murayama, Tokyo (JP); Hiroshi Kida, Tokyo (JP); Tsutomu Ohtani, Tokyo (JP); Nobuyuki Tadehara, Tokyo (JP)

Correspondence Address: YOUNG & THOMPSON, 745 SOUTH 23RD STREET, 2ND FLOOR, ARLINGTON, VA, 22202, US

(73) Assignee: PIONEER CORPORATION, TOKYO (JP)

(21) Appl. No.: 10/901,975

(22) Filed: Jul. 30, 2004

(30) Foreign Application Priority Data
Aug. 1, 2003 (JP) 2003-205419

(51) Int. Cl. H04N 11/20; H04N 3/27

(52) U.S. Cl. 348/445; 348/554

(57) ABSTRACT

An image display apparatus is provided with: a display device for displaying an image with a resolution of 1280×768; and an image processing device for making graphic video information for displaying a GUI, so as not to exceed the resolution of 1280×768 and according to a difference in resolution of primitive video information with a resolution of 1920×1080, and for combining the made graphic video information with the primitive video information. The display device extracts the graphic video information from the primitive video information, to thereby display the GUI based on the extracted graphic video information.

### BACKGROUND OF THE INVENTION

1. Field of the Invention

The present invention relates to an image display apparatus, such as a Plasma Display Panel (PDP), and more specifically, to an image display apparatus for performing image display including graphic image display, such as Graphical User Interface (GUI) display.

2. Description of the Related Art

There is conventionally known an image display apparatus, such as the PDP, capable of receiving a proper video signal or picture signal from a broadcast station and displaying an image on the basis of the video signal. With respect to the image display apparatus, there is known an apparatus which performs so-called “scaling” (or “scaling process”). Specifically, the scaling is as follows.

In general, there are some cases where the resolution of the video signal transmitted from the broadcast station disagrees with the resolution of the image display apparatus on the receiving side. For example, in a Standard Definition (SD) standard, the transmitted video signal is such a video signal with a resolution of 720×480 (horizontal resolution×vertical resolution: the same applies hereinafter). In a High Definition (HD) standard, the transmitted signal is such a video signal with a resolution of 1280×1080. If the image display apparatus on the receiving side is the PDP which is 50 inches type, there is a resolution of 1280×768. If so, it is impossible to display the video signal transmitted from the broadcast station as it is on the PDP. In such a case, what is performed in order to display an image based on the original video signal on the image display apparatus is the “scaling”. Specifically, the scaling is performed as processing for matching the resolution of the video signal with the resolution on the receiving side by operating a proper scaling function with respect to the original video signal, for example. In this case, how accurately the obtained video signal reflects the original video signal depends on how to determine the scaling function specifically.

Moreover, with respect to the above-described image display apparatus, there is known an apparatus for performing so-called “GUI display”. Here, the GUI display is, for example, a program listing of the day, a program reservation table for video recording, various messages, or the like. The GUI display is included in a broad concept of the “graphic image display”, including letters and a simple figure which are used for communicating with a user about various information, such as a weather forecast and traffic information in a data broadcast or the like, in addition to the above examples. The user can obtain various useful information by virtue of the GUI display, and according to circumstances, the user can transmit various commands, orders or the like to the apparatus side through the GUI display. Incidentally, Japanese Patent Application Laying Open NO. Hei 6-70234 discloses a technique of displaying the caption of a foreign movie, as one example of such GUI display.

However, the image display apparatus as described above has the following problem. Namely, if the scaling is performed on the image display apparatus for performing the above-described GUI display, the following failure or defect may occur in some cases. For example, firstly, it is assumed that the video signal based on the HD standard (a resolution of 1920×1080) is scaled to the PDP (a resolution of resolution of 1280×768), as described above. If it is tried to include the GUI display into the video signal, the GUI display is also scaled. However, in this case, the GUI display is also down-scaled (i.e., down-converted) in response to that the scaling is substantially down-scaling. If so, since the GUI display is the graphic image display mainly with letters or a simple figure or the like, a font is crashed so that it looks bad. What is worse, it becomes difficult to read it in some cases.

Secondly, it is assumed that the video signal based on the SD standard is scaled to the PDP. If it is tried to include the GUI display into the video signal, the GUI display is also scaled. However, in this case, as opposed to the above first case, the GUI display is also enlarged (i.e., up-scaled or up-converted) in response to that the scaling is substantially enlarged. In this case, the roughness of the font of letters or a simple figure or the like constituting the GUI display is easily seen so that it looks bad. What is worse, it becomes difficult to read it in some cases.

Thirdly, in the data broadcast based on the HD standard (which primarily includes the graphic image display), each picture element (pixel) on the graphic image display with a resolution of 960×540 is displayed twice in respective one of the horizontal direction and the vertical direction (which is hereinafter referred to as “double-frame-scan”), thereby to obtain the video signal with a resolution of 1920×1080. If this signal is scaled to the PDP, since the standard is special in a way, such scaling that it is once enlarged (the above-described double-frame-scan) and then down-scaled is performed in some cases. Then, the graphic image display is also once upsized and then down-scaled, which highly possibly deteriorates the image quality of the graphic image display severely in this case.

### SUMMARY OF THE INVENTION

It is therefore an object of the present invention to provide an image display apparatus capable of performing the graphic image display, such as the GUI display, in higher quality for example.

The above object of the present invention can be achieved by a first image display apparatus provided with: a display device for displaying an image with a resolution of u×v; and an image processing device for making second video information for a second image, so as not to exceed the resolution of u×v and according to a difference in resolution of first video information for displaying a first image with a resolution of p×q (wherein at least one of p≠u and q≠v is valid), and for combining the made second video information with the first video information, the display device extracting the second video information from the first video information, to thereby display the second video image based on the extracted second video information.

In the first image display apparatus of the present invention, the term “a resolution of a×b” has a meaning that the horizontal pixel number is “a” and that the vertical pixel number is “b”. The same is true hereinafter.

Particularly, in the first image display apparatus, the image processing device makes the second video information, so as not to exceed the resolution of u×v of the display device and according to a difference in resolution of the first video information for displaying the first image with a resolution of p×q. Here, it is easy to understand if it is assumed that the second image is mainly a graphic, such as the GUI mainly with letters or a simple figure or the like, and that the first image is mainly a normal TV image. According to this, the graphic, such as the GUI, is made so as not to exceed the resolution of u×v and according to the difference in resolution of the resolution of the TV image transmitted by broadcast.

Therefore, according to the first image display apparatus, it is possible to make the video information associated with the graphic, such as the GUI, appropriately and properly in advance, in a suitable form for both resolutions of the display device and the first video information. Thus, even if this is displayed, the failure or defect, such as crashing the font constituting the display of the data broadcast and emphasizing the roughness thereof, hardly occurs or does not occur at all. In the first image display apparatus, it is possible to perform the graphic image display, such as the GUI display, in higher quality.

Incidentally, “according to a difference in resolution of the first video information” specifically means according to a specific value of the resolution of p×q, a relationship between the resolution of p×q and the resolution of u×v, or the like. For example, it means that the second video information is made “so as to agree with the resolution of u (=p)×v if both of p=u and q>v are valid” or that the second video information is made “so as to agree with the resolution of u (=p)×q if both p=u and q<v are valid”, or the like.

Moreover, “to combine” in the first image display apparatus includes the meaning of “to superimpose or overlay”.

In one aspect of the first image display apparatus of the present invention, the second image includes a graphic image.

According to this aspect, it is possible to perform, in high quality, the GUI display or the like, included in the “graphic image display”, including letters and a simple figure used for communicating with a user about various information, such as a program listing of the day, a program reservation table for video recording, or a weather forecast and traffic information in the data broadcast, or the like.

In another aspect of the first image display apparatus of the present invention, the GUI includes an entire-screen GUI.

In this aspect, the “entire-screen GUI” means a GUI displayed by using substantially all of the image display area of the display device. Typically, the above-described program listing or the like applies to it. According to this aspect, it is possible to receive the operational effect of the first image display apparatus described above more appropriately. This is because of the following circumstances.

Namely, the first image display apparatus is constructed to “extract” the second video information, which is the basis of the second image, from the first video information to thereby display the second image. Thus, in the case of the GUI which is not the entire-screen GUI, most of the first video information is discarded, and most of the first image, which is essentially to be presented for a user, is not displayed.

In this aspect, the GUI is the entire-screen GUI, so that the second image in the first image display apparatus (consequently the second information) is also such (i.e. such as displayed by using substantially all of the image display area of the display device). Even if the extraction is not performed, the first image based on the first video information is not presented for a user in the first place (i.e. the entire-screen GUI is overlaid on most of the first image). If so, in this case, there is little possibility that most of the first image is presented for a user, in the first place. On the contrary, extracting the second video information does not cause disadvantage to the user.

In short, according to this aspect, it is possible to receive the operational effect of the first image display apparatus “more appropriately” in the sense that the GUI can be displayed in high quality without sacrificing the information to be informed to a user in the first video information.

In another aspect of the first image display apparatus of the present invention, the resolution of p×q includes a resolution of 1280×1080, the resolution of u×v includes a resolution of 1280×768, and the second video information is made to have a resolution of 1280×768.

According to this aspect, for example, if the first video information is based on the so-called HD standard, it is possible to display the second image preferably. Incidentally, in this case, if the second image includes the GUI, it can be said that the GUI includes the entire-screen GUI.

In another aspect of the first image display apparatus of the present invention, the resolution of p×q includes a resolution of 1280×720, the resolution of u×v includes a resolution of 1280×768, and the second video information is made to have a resolution of 1280×720.

According to this aspect, for example, if the first video information is based on the so-called SD standard, it is possible to display the second image preferably. Incidentally, in this case, if the second image includes the GUI, it can be said that the GUI includes the entire-screen GUI.

Incidentally, in the case of this aspect, although the vertical resolution of the second image based on the second video information is 720, the vertical resolution of the display device is 768, so that there is an disagreement of 48 lines between the both. Therefore, if the image display is actually performed according to this aspect (i.e. if the image display associated with the second image is performed), black bands may be displayed with them sandwiching the second image and each of the upper and lower bands being 24 lines.

The above object of the present invention can be achieved by a second image display apparatus provided with: a display device for displaying an image with a resolution of u×v; and a scaling device for performing such a scaling process that primitive video information with a resolution of r×s is converted to video information for display for the resolution of u×v (wherein at least one of r≠u and s≠v is valid), the scaling device performing the scaling process only once with respect to the primitive video information.

According to the second image display apparatus of the present invention, it is provided with the scaling device. Thus, basically, regardless of the resolution of the received primitive video information, it is possible to display an image matching the resolution of the display device by performing the scaling process. For example, if both r>u and s>v are valid, it is possible to match the resolution of the display device by scaling which is substantially down-scaling (i.e., down-converting). On the other hand, if both r<u and s<v are valid, it is possible to match the resolution of the display device by scaling which is substantially enlarging (i.e., up-scaling or up-converted). Incidentally, with respect to the “scaling process”, various specific aspects can be considered, but to put it simply, the following aspect can be considered: e.g. properly thinning out some information out of the primitive video information, adding it, or performing proper interpolation.

Particularly, in the second image display apparatus, if the resolution of the primitive video information includes 960×540 and the resolution of the display device includes 1280×768, it is necessary to scale the primitive video information with a resolution of 960×540 to the video information for display with a resolution of 1280×768.

Considering that the video information based on the HD standard has a resolution of 1920×1080, it is understood that the primitive video information with a resolution of 960×540 assumed in this aspect has half the horizontal pixel and half the vertical pixel regarding the HD standard. Therefore, if the scaling of the primitive video information based on the HD standard (which is hereinafter referred to as the “scaling for HD” for convenience of explanation) can be performed on the scaling device of the second image display apparatus, it is efficient to perform the scaling for HD prepared in advance to the video information with a resolution of 1920×1080 after the video information with a resolution of 1920×1080 is obtained by the “double-frame-scan” of the primitive video information with the resolution of 960×540, and it is unnecessary to complicate a circuit structure of the like of the scaling device.

However, as described in the Description of the Related Art, performing the double-frame-scan may deteriorate the image quality; for example, crashing the font of the graphic, such as the GUI, or emphasizing the roughness thereof, or the like.

According to the second image display apparatus, the scaling device scales the primitive video information with the resolution of 960×540 only once. According to this, the double-frame-scan is omitted so that it is possible to avoid the deterioration of the image quality. Thus, the failure or defect, such as crashing the font constituting the display of the data broadcast and emphasizing the roughness thereof, hardly occurs or does not occur at all. According to the second image display apparatus, it is possible to perform the graphic image display, such as the GUI display, in higher quality.

In one aspect of the second image display apparatus of the present invention, the primitive video information includes video information of a data broadcast based on a High Definition (HD) standard.

According to this aspect, it is generally known that the data broadcast based on the HD standard is transmitted as the primitive video information with the resolution of the 960×540, so that the failure or defect, such as crashing the font constituting the display of the data broadcast and emphasizing the roughness thereof, hardly occurs or does not occur at all. In other words, the second image display apparatus is applied in the case of receiving the data broadcast, and this provides the most preferable one aspect.

In another aspect of the second image display apparatus of the present invention, the scaling device may be constructed such that it is capable of scaling the primitive video information in which the resolution r×s is a resolution of 1920×1080.

According to this aspect, the scaling device is capable of scaling the primitive video information based on the HD standard. Therefore, if that is taken simply, it can be said that it is efficient to perform the double-frame-scan and then the scaling for HD to the primitive video information with a resolution of 960×540, as descried above. However, this causes the deterioration of the image quality as described above.

Thus, it can be said that even if the scaling device has a capability of scaling the primitive video information based on the HD standard, as constructed in this aspect, it is preferable not to use the capability as it is upon receiving the primitive video information with a resolution of 960×540, but to perform the only one scaling, which is the feature of the second image display apparatus.

As described above, according to this aspect, although it seems inefficient, it is more effective in the sense that it is possible to display an image with a resolution of 960×540 of the data broadcast or the like in high quality. According to this aspect, it is also possible to preferably display an image based on the primitive video information based on the HD standard in addition to the primitive video information with a resolution of 960×540.

The above object of the present invention can be achieved by a third image display apparatus provided with: a display device for displaying an image with a resolution of u×v; a scaling device for performing such a scaling process that primitive video information with a resolution of r×s is converted to video information for display for the resolution of u×v (wherein at least one of r≠u and s≠v is valid); and an image processing device for making graphic video information for displaying a graphic image harmonized with the resolution of r×s and for combining the made graphic video information with the primitive video information, the scaling device provided with: a first image processing device for performing an imaging process for the primitive video information including the scaling process; and a second image processing device for performing an imaging process for the graphic video information which is different from the imaging process for the primitive video information.

According to the third image display apparatus of the present invention, it is provided with the scaling device. Thus, basically, regardless of the resolution of the received primitive video information, it is possible to display an image matching the resolution of the display device by performing the scaling.

Particularly in the third image display apparatus, the image processing device makes the graphic video information for displaying a graphic image harmonized with the resolution of r×s and combines the made graphic video information with the primitive video information. Generally, the image “harmonized with” a resolution of ax b includes a meaning that the video information for constituting the image is made on the basis of coordinates with the resolution of a×b. The same is also true hereinafter if the same term is used. Therefore, in the above case, it is difficult to display the graphic image based on the graphic video information as it is on the display device (because at least one of r≠u and s≠v is valid), so that the scaling is necessary somehow.

Moreover, in the third image display apparatus, the scaling device is provided with: the first image processing device for performing the imaging process for the primitive video information; and the second image processing device for performing the imaging process for the graphic video information. They are constructed such that the imaging processes different between the former and the latter device are performed.

Here, as the “different imaging processes”, the following processes can be considered: for example, the primitive video signal is scaled after an “imperfect” interlace-progressive conversion (hereinafter referred to as an “ip conversion”) is performed, and the GUI is scaled after a “perfect” ip conversion is performed. The “ip conversion” means to convert the primitive video information with interlace scan to video information with progressive scan, in order to make it the video information for display. To be “imperfect” and “perfect” merely has such a relative meaning that one is perfect or imperfect with respect to the other. It does not mean that the quality of an image after the ip conversion deteriorates severely even if it is “imperfect”. It does not mean that there is no conversion error in the ip conversion even if it is “perfect” (refer to the relevant description in the detailed description of the preferred embodiments about other examples of to be perfect and imperfect).

According to the example described above, the graphic video information has a higher possibility that the original data is: maintained as it is after the ip conversion than the primitive video information, and is capable of displaying a finer image. In this case, even if the same scaling is executed to the information after the ip conversion, the graphic image maintains the preciseness and the fineness.

As described above, according to the third image display apparatus, the failure or defect, such as crashing the font constituting the display of the data broadcast and emphasizing the roughness thereof, hardly occurs or does not occur at all. It is possible to perform the graphic image display, such as the GUI display, in higher quality.

In one aspect of the third image display apparatus of the present invention, the third image display apparatus is further provided with: a key signal generating device for generating a key signal for identifying at which position of the primitive video signal the graphic video information is combined, the scaling device using, for image display, any one of (i) video information passed through the first image processing device and (ii) video information passed through the second image processing device according to the generated key signal.

According to this aspect, by the presence of the key signal, it is possible to preferably use the first image processing device and the second image processing device properly according to a difference in resolution between the primitive video information and the graphic video information. As the way to use the key signal, it is possible to adopt such a construction that “the first image processing device and the second image processing device are separately operated according to the generated key signal”, in addition to the above-described construction. In the above-described construction, the key signal is used in determining which video information passed from the first and the second image processing devices is used for the actual image display. However, this aspect is constructed such that the operations themselves of the first and the second image processing devices are controlled by the key signal.

The above object of the present invention can be achieved by a fourth image display apparatus provided with: a display device for displaying an image with a resolution of u×v; a scaling device for performing such a scaling process that primitive video information with a resolution of r×s is converted to video information for display for the resolution of u×v (wherein at least one of r≠u and s≠v is valid); and an image processing device for making graphic video information for displaying a graphic image harmonized with the resolution of u×v and for combining the made graphic video information with the video information for display.

According to the fourth image display apparatus of the present invention, it is provided with the scaling device. Thus, basically, regardless of the resolution of the received primitive video information, it is possible to display an image matching the resolution of the display device by performing the scaling.

Particularly in the fourth image display apparatus, the image processing device makes the graphic video information for displaying a graphic image harmonized with the resolution of u×v and combines the made graphic video information with the video information for display. Here, “harmonized” has the above-described meaning.

Therefore, in this case, as opposed to the third image display apparatus, the graphic video information is made in a form matching the resolution of u×v of the display device from the beginning. By combining it with the video information for display, it is possible to display the graphic image based on the graphic video information as it is on the display device. As described above, making the graphic video information in a form harmonized with the resolution of u×v from the beginning means that it is possible to make the graphic video information appropriately and properly without crashing the font or the like constituting the graphic or emphasizing the roughness thereof. In this case, the graphic video information does not have to be scaled. Thus, according to the fourth image display apparatus, it is possible to perform the graphic image display, such as the GUI display, in higher quality.

The above object of the present invention can be achieved by a fifth image display apparatus provided with: a display device for displaying an image with a resolution of u×v; a scaling device for performing such a scaling process that primitive video information with a resolution of r×s is converted to video information for display for the resolution of u×v (wherein at least one of r≠u and s≠v is valid); an image processing device for making graphic video information for displaying a graphic image harmonized with the resolution of r×s; and an inverse scaling device for performing an inverse process of the scaling process with respect to the graphic video information, to thereby make inverse-scaled video information, the scaling device performing the scaling process with respect to both of the primitive video information and the inverse-scaled video information.

According to the fifth image display apparatus of the present invention, it is provided with the scaling device. Thus, basically, regardless of the resolution of the received primitive video information, it is possible to display an image matching the resolution of the display device by performing the scaling.

Particularly in the fifth image display apparatus, the image processing device makes the graphic video information for displaying a graphic image harmonized with the resolution of r×s and combines the graphic video information with the primitive video information. Here, “harmonized” has the above-described meaning.

The fifth image display apparatus is further provided with the inverse scaling device for performing the inverse process of the scaling process with respect to the graphic video information. The “inverse process” can be considered such as conceptually expressed as an operation of “f⁻¹” if the scaling can be expressed as an operation of a certain scaling function “f”. More specifically and intuitively, for example, if the scaling process applies to down-scaling (i.e., down-converting), the inverse process thereof is enlarging (i.e., up-scaling or up-converting). If the scaling process applies to enlarging, the inverse progress thereof is down-scaling.

In addition, in the fifth image display apparatus, both the primitive video information and the inverse-scaled video information, which is the graphic video information to which the inverse processing is performed, are scaled. Therefore, at this time, the graphic video information returns to be its “natural state”, so to speak.

As described above, the fifth image display apparatus is constructed such that the graphic video information is scaled after the inverse process of the scaling process. Thus, after the scaling process, the graphic video information made at the beginning is obtained, and the graphic image based on the graphic video information is obtained. In other words, such a failure or defect that the font or the like is crashed or that the roughness thereof is emphasized, which is caused by the scaling, is canceled or compensated by inserting the inverse process in advance, so that it is possible to realize not to generate the failure or defect. Thus, according to the fifth image display apparatus, it is possible to perform the graphic image display, such as the GUI display, in higher quality.

In another aspect of the first to fifth image display apparatuses, the display device includes a Plasma Display Panel (PDP). According to this aspect, the display includes the PDP, so that it is possible to perform the high-quality image display.

As described above, the first image display apparatus of the present invention is provided with: the display device; and the image processing device, the display device extracting the second video information from the first video information, to thereby display the second image based on the extracted second video information. Thus, it is possible to make the video information associated with the graphic, such as the GUI, appropriately and properly in advance, in a suitable form for both resolutions of the display device and the first video information. Thus, according to the first image display apparatus, it is possible to perform the graphic image display, such as the GUI display, in higher quality.

The second image display apparatus of the present invention is provided with: the display device; and the scaling device, the scaling device performing the scaling process only once with respect to the primitive video information. It is unnecessary to perform the above-described “double-frame-scan. Thus, according to the second image display apparatus, it is possible to perform the graphic image display, such as the GUI display, in higher quality.

The third image display apparatus of the present invention is provided with: the display device; the scaling device; and the image processing device, the scaling device further provided with: the first image processing device; and the second image processing device. By virtue of the first and second image processing devices, it is possible to perform such an image conversion that the graphic video information maintains the fineness more than the primitive video information, for example. Thus, according to the third image display apparatus, it is possible to perform the graphic image display, such as the GUI display, in higher quality.

The fourth image display apparatus of the present invention is provided with: the display device; the scaling device; and the image processing device. It is possible to make the graphic video information in a form harmonized with the resolution u×v of the display device from the beginning. Thus, according to the fourth image display apparatus, it is possible to perform the graphic image display, such as the GUI display, in higher quality.

The fifth image display apparatus of the present invention is provided with: the display device; the scaling device; the image processing device; and the inverse scaling device. The graphic video information can be scaled after the inverse process of the scaling process. Thus, according to the fifth image display apparatus, it is possible to perform the graphic image display, such as the GUI display, in higher quality.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram showing a structure example of an image display apparatus in a first embodiment;

FIG. 2 is a flowchart showing the flow of GUI displaying by the image display apparatus shown in FIG. 1;

FIG. 3 is an explanatory diagram showing one processing in the displaying shown in FIG. 2 on a conceptual basis and showing processing in the case of performing entire-screen GUI display (and in the case where a resolution of a primitive or original video signal is 1920×1080);

FIG. 4 is an explanatory diagram showing one processing in the displaying shown in FIG. 2 on a conceptual basis and showing processing in the case of performing the entire-screen GUI display (and in the case where a resolution of the primitive video signal is 1280×780);

FIG. 5 is an explanatory diagram showing one processing in the displaying shown in FIG. 2 on a conceptual basis and showing processing in the case of a data broadcast;

FIG. 6 is a comparison example with respect to FIG. 5;

FIG. 7 is an explanatory diagram showing one processing in the displaying shown in FIG. 2 on a conceptual basis and showing processing in the case of performing the GUI display partially (and in the case where a resolution of the primitive video signal is 1920×1080);

FIG. 8 is an explanatory diagram showing one processing in the displaying shown in FIG. 2 on a conceptual basis and showing processing in the case of performing the GUI display partially (and in the case where a resolution of the primitive video signal is 720×480);

FIG. 9 is a comparison example with respect to FIG. 7;

FIG. 10 is a comparison example with respect to FIG. 8;

FIG. 11 is a block diagram showing a structure example of an image display apparatus in a second embodiment;

FIG. 12 is a flowchart showing the flow of GUI displaying by the image display apparatus;

FIG. 13 is an explanatory diagram showing one processing in the displaying shown in FIG. 12 on a conceptual basis;

FIG. 14 is a block diagram showing a structure example of an image display apparatus in a third embodiment;

FIG. 15A to FIG. 15C show one specific example of the basis of and how to obtain an inverse function and a scaling function to be operated to the GUI or the like on an inverse function operating device and a scaler shown in FIG. 14;

FIG. 16 is a flowchart showing the flow of GUI displaying by the image display apparatus; and

FIG. 17 is an explanatory diagram showing one processing in the displaying shown in FIG. 16 on a conceptual basis.

### DETAILED DESCRIPTION OF THE PREFERRED EMBODIMENTS

The embodiments associated with the display device of the present invention will be explained with reference to the drawings hereinafter.

(First Embodiment—in the Case of Including an Entire-Screen GUI)

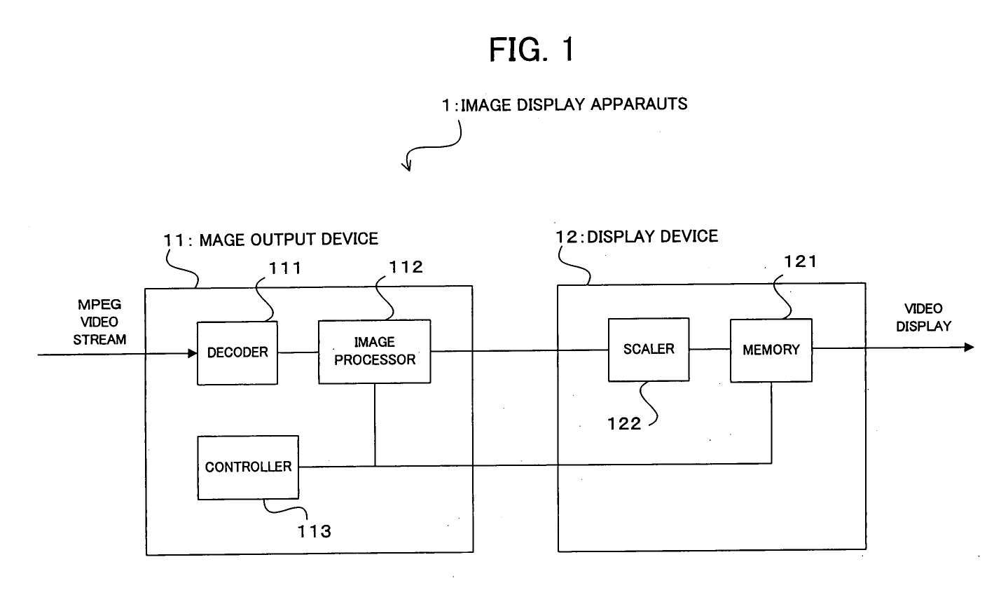

Firstly, the structure of an image display apparatus 1 associated with the first embodiment will be explained with reference to FIG. 1. FIG. 1 shows a structure example of the image display apparatus 1 in the first embodiment.

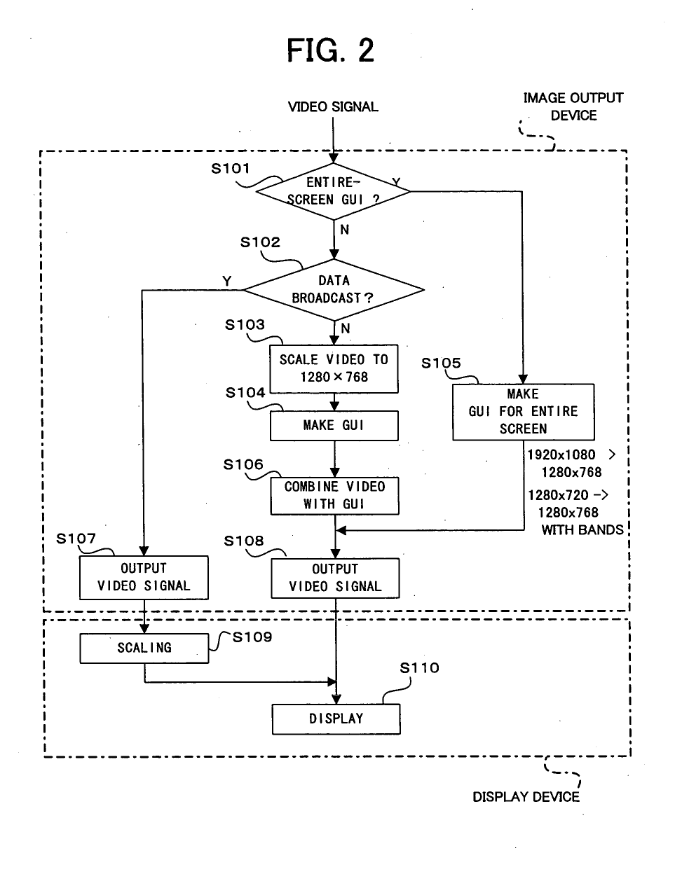

In FIG. 1, the image display apparatus 1 is provided with: an image output device 11, such as a TV broadcast receiver; and a display device 12, such as the PDP. Out of them, the image output apparatus 11 includes: a decoder 111; an image processor 112; and a controller 113. The decoder 111 decodes a received Moving Picture Expert Group (MPEG) video stream, for example. The image processor 112 executes an appropriate imaging process with respect to the video signal decoded by the decoder 111. The controller 113 is a controlling device for harmoniously operating the decoder 111 and the image processor 112 described above. Particularly, in the first embodiment, the controller 113 is constructed to judge whether or not to include an entire-screen GUI into the video signal received from the outside, or judge what standard the video signal is based on (e.g. refer to a step S101 and a step S102 in FIG. 2), and instruct the image processor 112 of processing for realizing the appropriate display of the GUI on the basis of the judgment. The image processor 112 responds to this instruction and makes the entire-screen GUI, for example (refer to a step S105 in FIG. 2).

On the other hand, the display device 12 is, for example, the PDP and includes: a memory 121; and a scaler 122, as shown in FIG. 1. The display device 12 associated with the first embodiment is set to have a resolution of 1280×768. The memory 121 is constructed from a known storage element capable of reading and writing as needed, and is used for temporarily storing therein the video signal received from the image output device 11. If the video signal received from the image output device 11 mismatches with the above-described resolution of 1280×768 of the display device 12, the scaler 122 performs such a process that the resolution of the video signal is matched with the resolution of the display device 12 (i.e. performs the scaling or the scaling process).

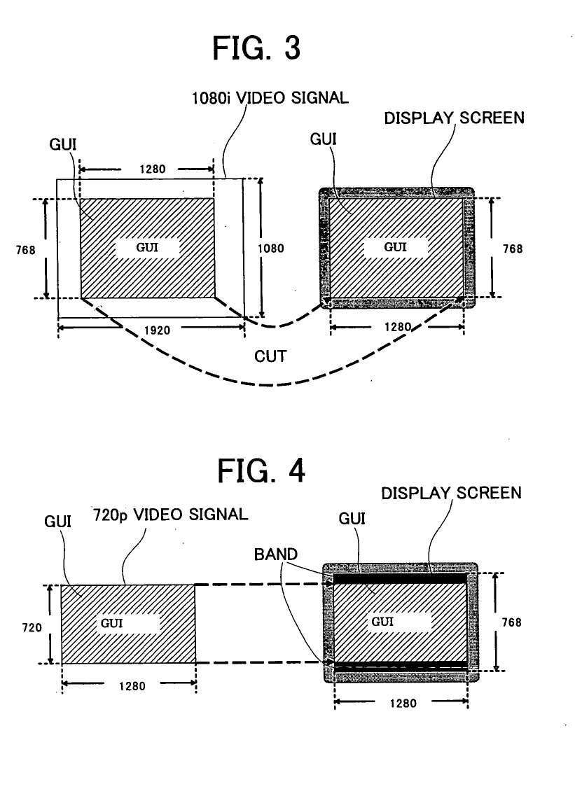

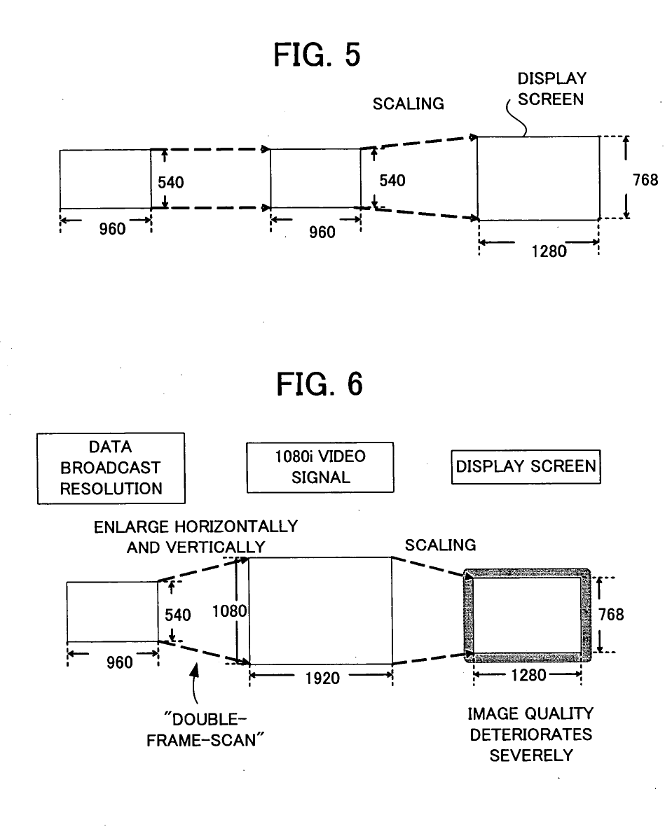

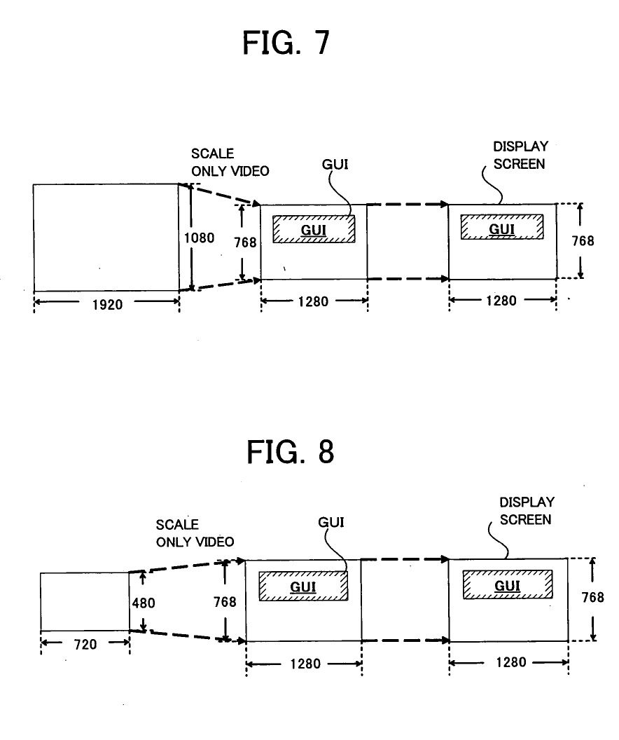

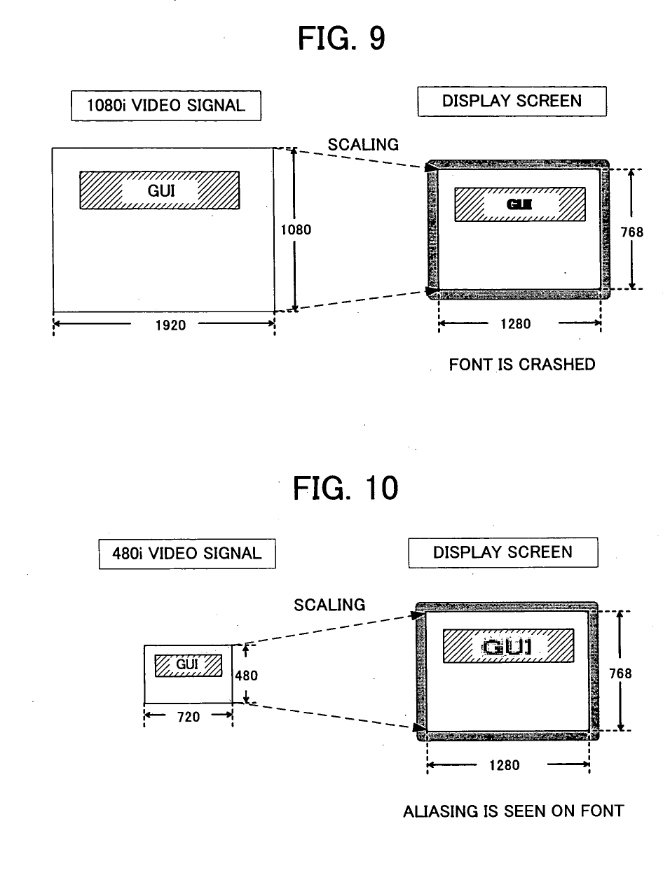

According to the image display apparatus 1 constructed in this manner, it is operated as shown in FIG. 2, and as a result, the following operational effect is obtained. FIG. 2 shows the flow of GUI displaying by the image display apparatus shown in FIG. 1. FIG. 3 to FIG. 5, FIG. 7, and FIG. 8 all show one processing in the displaying shown in FIG. 2 on a conceptual basis, FIG. 3 and FIG. 4 showing processing in the case of performing entire-screen GUI display, FIG. 5 showing processing in the case of a data broadcast, FIG. 7 and FIG. 8 showing processing in the case of performing the GUI display partially. Incidentally, FIG. 8, FIG. 9, and FIG. 10 are comparison examples with respect to FIG. 5, FIG. 7, and FIG. 8, respectively.

At first, the image output device 11 judges whether or not it is the case of displaying the entire-screen GUI (the step S101 in FIG. 2). If it is judged to be the case of displaying the entire-screen GUI (the step S101: Y), the image processor 112 makes a GUI for the entire screen (the step S105). The making of the GUI for the entire screen means the making of a GUI which is not beyond 1280×768 that is the resolution of the display device 12 and which corresponds to a difference of the original video signal (which is a video signal received by the image output device 11 at the beginning and which is hereinafter referred to as the “primitive video signal”) (refer to FIG. 3 and FIG. 4 and their explanations). Then, the image output device 11 outputs, to the display device 12, a video signal obtained by superimposing or overlaying the GUI for the entire screen made in the above manner onto the primitive video signal (which is hereinafter referred to as a “superimposed video signal”) (step S108 in FIG. 2). The display device 12, which receives this signal, extracts only a portion corresponding to the GUI from the superimposed video signal and stores it into the memory 121 once. Then, it reads and displays the GUI stored in the memory 121 (step S110 in FIG. 2).

More specifically, in this case, it can be considered that the resolution of the primitive video signal is 1920×1080 (i.e. a video signal with “1080i (interlace)” in the HD standard) or that the resolution is 1280×720 (i.e. a video signal with “720p (progressive)” in the HD standard). FIG. 3 and FIG. 4 show the making of the GUI for the entire screen and the display of an image based on the superimposed video signal, FIG. 3 showing the case where the resolution of the primitive video signal is 1920×1080, FIG. 4 showing the case of 1280×720.

In FIG. 3, if the resolution of the primitive video signal is 1920×1080, the image output device 11 makes a GUI for the entire screen with a resolution of 1280×768, superimposes this onto the primitive video signal, and transmits the superimposed video signal to the display device 12. Then, the display device 12 extracts only a portion corresponding to the above-described GUI made for the entire screen (i.e. an image with a resolution of 1280×768) from the superimposed video signal, and stores it into the memory 121 once. Then, by reading out the data stored in the memory 121, such an image that the entire screen is covered with the GUI is displayed on the display device 12, as shown on the right in FIG. 3.

On the other hand, if the resolution of the primitive video signal is 1280×720, the image output device 11 makes a GUI for the entire screen with a resolution of 1280×720, superimposes this onto the primitive video signal, and transmits the superimposed video signal to the display device 12. Then, the display device 12 displays the GUI for the entire screen as it is. In this case, the vertical resolution of the primitive video signal is 720, so that it does not satisfy the vertical resolution of 768 on the display device 12. Therefore, on the screen of the display device 12, bands including no information (i.e. black bands) are displayed on the top and bottom of the GUI for the entire screen, as shown on the right in FIG. 4.

On the other hand, if it is judged to be the case of not displaying the entire-screen GUI in the above-described step S101 (the step S101: N), then it is judged whether or not the primitive video signal received by the image output device 11 is from the data broadcast based on the HD standard (i.e. whether or not it is a video signal with a resolution of 960×540 and that the broadcast itself is constructed from the graphic image display) (the step S102 in FIG. 2). Here, if it is judged that the primitive video signal is from the data broadcast based on the HD standard (the step S102: Y), the image output device 11 outputs the primitive video signal as it is to the display device 12 (step S107 in FIG. 2). Then, the display device 12, which receives this signal, scales the primitive video signal on the scaler 122 (step S109 in FIG. 2) and displays an image (step S110 in FIG. 2). Incidentally, FIG. 5 shows the processing in the above-described step S107 as a transition from the left to the center in FIG. 5 and the processing in the above-described step S109 as a transition from the center to the right in FIG. 5.

With respect to this point, in the comparison example as in a conventional case shown in FIG. 6, if the primitive video signal is from the data broadcast based on the HD standard, imaging is performed twice as follows: a video signal with a resolution of 960×540 is firstly double-frame-scan-processed with respect to a video signal with a resolution of 1920×1080 (i.e. a transition from the left to the center in FIG. 6), and is further down-scaled to a video signal with a resolution of 1280×768 (i.e. a transition from the center to the right in FIG. 6). Incidentally, according to the double-frame-scan in the former half of the above imaging, the resolution of the video signal obtained by the enlarging is 1920×1080, which is the same as that of the video signal in the HD standard. Thus, in the scaling in the latter half of the above imaging, it is possible to perform the same operation as the scaling of the video signal based on the HD standard.

However, in such a case, the font of letters or the like is once enlarged and is then down-scaled. Therefore, the font is crashed so that it looks bad. What is worse, it may become difficult to read it in some cases. In short, the execution of the imaging process twice as described above highly possibly deteriorates the image quality of the graphic image display severely.

However, in the first embodiment, if the primitive video signal is from the data broadcast based on the HD standard, the imaging is performed only once (refer to the step 107 and the step S109 in FIG. 2 and FIG. 5), so that the failure or defect described above hardly occurs or does not occur at all.

Next, if it is judged in the above-described step S102 that the primitive video signal is not from the data broadcast based on the HD standard (the step S102: N) (in which case, it is also judged that the entire-screen GUI is not displayed. Refer to the step S101), the image output device 11 scales the primitive video signal to a video signal with a resolution of 1280×768 (step S103 in FIG. 2). Then, the image output device 11 separately makes a GUI to be displayed with the primitive video signal (step S104 in FIG. 2) and combines the GUI with the primitive video signal (step S106 in FIG. 2). Then, the image output device 11 transmits the combined video signal to the display device 12 (the step S108 in FIG. 2). The display device 12, which receives this signal, displays an image on the basis of the combined video signal (the step S110 in FIG. 2).

More specifically, in this case, it can be considered that the resolution of the primitive video signal is 1920×1080 (i.e. a video signal with “1080i” in the HD standard) or that the resolution is 720×480 (i.e. a video signal with “480i” in the SD standard). FIG. 7 and FIG. 8 conceptually show the making of the GUI for the entire screen and the display of an image based on the combined video signal, FIG. 7 showing the case where the resolution of the primitive video signal is 1920×1080, FIG. 8 showing the case of 720×480.

With respect to this point, in the comparison example as in a conventional case shown in FIG. 9, if the primitive video signal is based on the HD standard, the video signal is scaled with the GUI included. Therefore, letters or the like displayed as the GUI are consequently down-scaled. The font is crashed (a space to be open is bridged or filled) so that it looks bad. What is worse, it may become difficult to read it in some cases. However, as described above, the first embodiment is constructed to make the GUI, combine it with the scaled primitive video signal, and then display it, so that the failure or defect described above hardly occurs or does not occur at all. Even if the primitive video signal is based on the SD standard, the video signal is scaled with the GUI included, as shown in FIG. 10. Therefore, letters or the like displayed as the GUI are consequently enlarged. The roughness of the font is easily seen (i.e. aliasing is seen) so that it looks bad. What is worse, it may become difficult to read it in some cases. However, as described above, the first embodiment is constructed to make the GUI, combine it with the scaled primitive video signal, and then display it, so that the failure or defect described above hardly occurs or does not occur at all.

As described above, according to the first embodiment having the above-described structure and operation, it is possible to perform the GUI display in high quality.

(Second Embodiment—Embodiment Using a Key Signal)

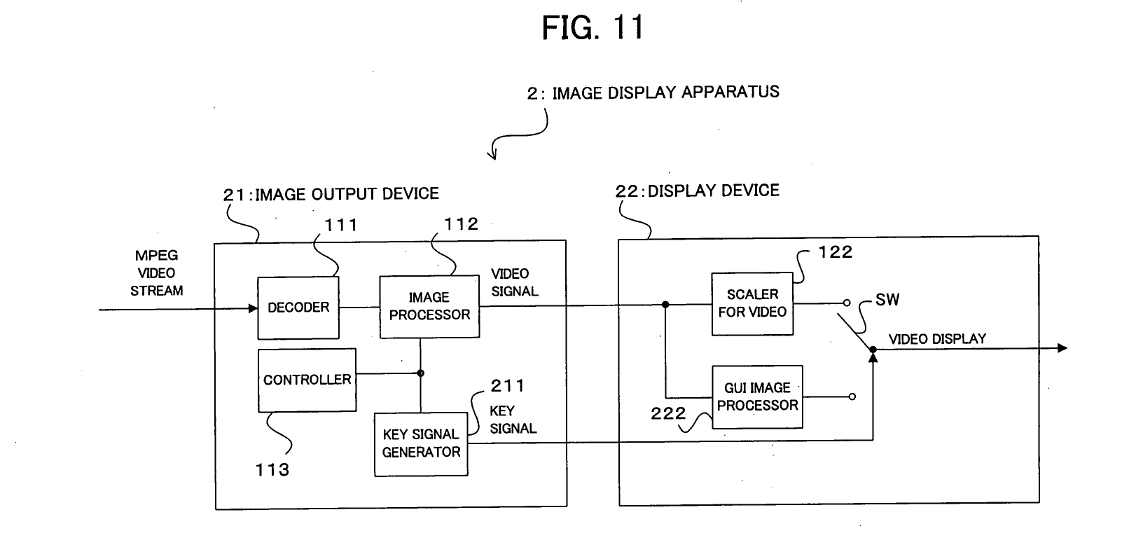

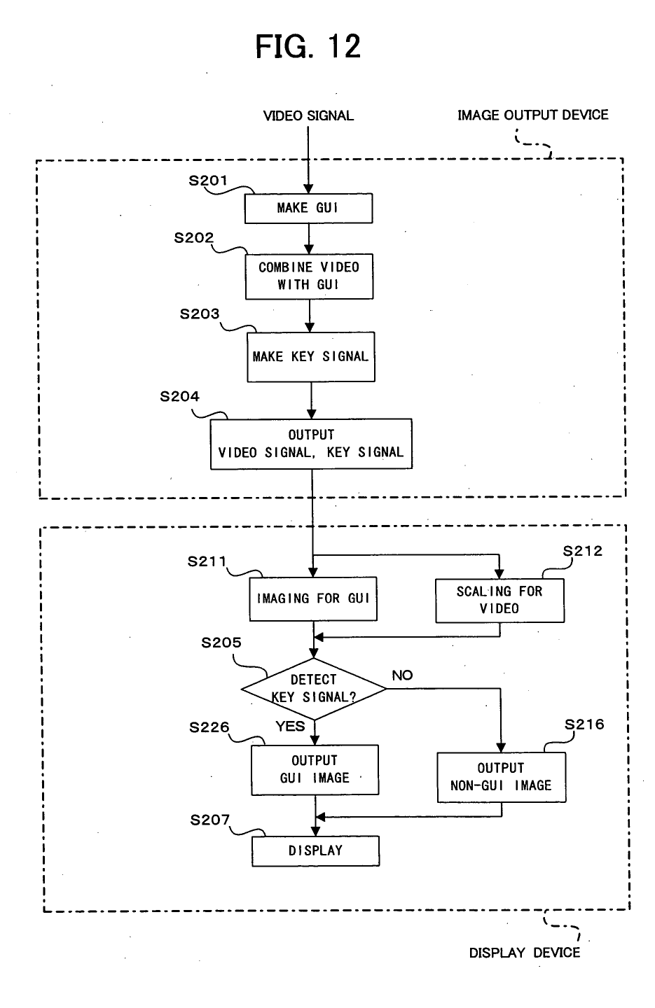

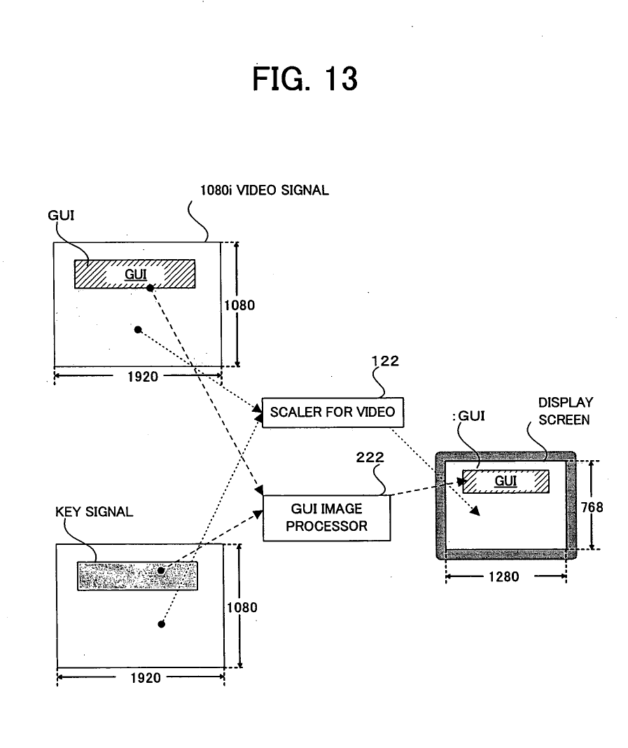

Next, with reference to FIG. 11 to FIG. 13, the second embodiment associated with the display device of the present invention will be explained. FIG. 11 shows a structure example of an image display apparatus in the second embodiment. FIG. 12 shows the flow of GUI displaying by the image display apparatus. FIG. 13 shows one processing in the displaying shown in FIG. 12 on a conceptual basis. With respect to the image display apparatus in the second embodiment, the explanation for the same or overlapping structure as compared with the above-described first embodiment will be omitted or simplified below. The feature in the second embodiment will be mainly explained. In the drawings which are referred to below, if indicating substantially the same elements of the image display apparatus in the first embodiment, the constitutional elements carry the same reference numerals already used above.

In FIG. 11, as opposed to the above-described image display apparatus 1 in the first embodiment, an image display apparatus 2 is provided with: an image output device 21 including a key signal generator 211; and a display device 22 including a GUI image processor 222 and a switch SW as being one example of the “selecting device”. Out of them, the key signal generator 211 generates a key signal for identifying at which position of the primitive video signal the GUI made on the image processor 112 of the image output device 11 is combined. In the second embodiment, by virtue of the presence of the key signal, it is possible to judge, on the display device 22, at which position of the primitive video signal the GUI is to be combined. On the other hand, the GUI image processor 222 executes special processing, which is different from the processing for the primitive video signal, with respect to the GUI made on the image processor 112, on the basis of the presence or absence of the key signal. A specific example of the “special processing” will be described later. On the image display apparatus 2 associated with the second embodiment, an image is displayed on the basis of the video signals transmitted from the GUI image processor 222 and the scaler 122 for normally scaling the primitive video signal. Out of the signals outputted from the GUI image processor 222 and the scaler 122, a signal for constituting the final video is selected by the operation of the switch SW which operates according to the key signal emitted from the key signal generator 211.

According to the image display apparatus 2 constructed in this manner, it is operated as shown in FIG. 12 and FIG. 13, and as a result, the following operational effect is obtained. In FIG. 12, at first, the image output device 21 receives the primitive video signal. Then, it makes a GUI (step S201 in FIG. 12) and combines the GUI with the primitive video signal (step S202 in FIG. 12). Upon making or combining the GUI, the key signal is generated on the key signal generator 211 (step S203 in FIG. 12). The key signal is a signal for identifying at which position of the primitive video signal the GUI made in the above manner is to be combined. To put this in FIG. 11, the image processor 112 transmits such indication that the GUI is made to the key signal generator 211, and the key signal generator 211 receives this indication and knows a generation timing of the key signal. The actual generation of the key signal depends on the generation timing. Through the above processes, the image output device 21 transmits the video signal (obviously including the video signal about the made GUI), and the key signal in the case of matching the generation timing, to the display device 22 (step S204 in FIG. 12).

Next, on the display device 22, the transmitted video signal is transmitted to both the scaler 122 and the GUI image processor 222. If based on the normal scaling, i.e. the HD standard with a resolution of 1920×1080, the video signal transmitted to the scaler 122 is scaled, which is substantially down-scaled to be a resolution of 1280×768 (step S212 in FIG. 12, refer to FIG. 7). On the other hand, not the normal scaling but the special processing is executed to the video signal transmitted to the GUI image processor 222 (step S211 in FIG. 12). Here, the “special” in the “special processing” specifically includes such a meaning that it is special in comparison with the scaling of the scaler 122. The specific aspect thereof will be described in detail later.

Next, the presence or absence of the key signal is detected on the display device 22 (step S205 in FIG. 12). Since the key signal generator 211 is informed of the generation timing in the sense of at which position of the primitive video signal the GUI is to be combined, as described above, the key signal is generated according to the generation timing. On the display device 22, according to the presence or absence of the key signal (refer to the step S204 in FIG. 12), which is consequently generated intermittently as described above, a portion for the GUI and a portion in which the primitive video signal is to be displayed as it is are distinguished from among the above-described video signal. If the key signal is detected (step S205: Yes), the switch SW is operated to contact with a lower terminal in FIG. 11, and an image after the imaging on the GUI image processor 222 (i.e. a GUI image) is outputted (step S226 in FIG. 11). If the key signal is not detected (step S205: No), the switch SW is operated to contact with an upper terminal in FIG. 11, and an image after the imaging on the scaler 122 (i.e. the scaling) is outputted (step S216 in FIG. 12). Then, in the end, a combined image of these is displayed (step S207 in FIG. 12).

According to the display of the combined signal described above, it is possible to perform the GUI display in high quality. This is because the “special processing” in comparison with the scaler 122 is preferably executed on the GUI image processor 222. Here, the following examples can be given to the “special processing”, for example.

As a first specific example of the “special processing”, the following processing can be considered; namely, the primitive video signal is scaled after an “imperfect” interlace-progressive conversion (hereinafter referred to as an “ip conversion”) is performed, and the GUI is scaled after a “perfect” ip conversion is performed. In this case, the “imperfect” or “perfect” ip conversion has the following meaning. Namely, the “imperfect” ip conversion specifically means such an ip conversion that a processing speed is relatively high or that the degree of original data being lost from the primitive video signal is relatively large. The reason such an ip conversion is possible is that a complete and perfect ip conversion for all scan lines is impossible in principle because the primitive video signal includes a motion image or a movie usually. Incidentally, from this point, it is understood that the “imperfect” ip conversion does not mean an ip conversion into an image whose image quality is severely deteriorated. As opposed to the above, the “perfect” ip conversion means such an ip conversion that a processing speed is relatively low or that the degree of original data being lost from the primitive video signal is relatively small. The reason such an ip conversion is performed is that a complete and perfect ip conversion for all scan lines is possible (wherein the “complete and perfect” only has a relative meaning in comparison with the above “imperfect”) because the primitive video signal includes a still image usually (or the reason is that once the conversion is performed, the subsequent conversion is unnecessary).

As descried above, to be “imperfect” and “perfect” can include a meaning of a difference in the accuracy of the ip conversion which can be determined on the basis of whether or not the video signal includes the motion image or the movie. If the perfect ip conversion is performed, the original data included in the original video signal is highly possibly stored as it is, and it is possible to display a finer image.

Therefore, by providing such a difference as described above, the GUI display after the perfect ip conversion is possibly more precise and finer than the GUI display after the imperfect ip conversion. In this case, even if the same scaling is executed to a signal after the ip conversion, the GUI display maintains the preciseness and the fineness. Incidentally, FIG. 13 shows such processing on a conceptual basis. The upper left in FIG. 13 shows the image display based on a primitive video signal with a resolution of 1920×1080 and a GUI on a conceptual basis. The lower left in FIG. 13 shows the addition of a key signal corresponding to a portion in which the GUI display with the same resolution is to be performed on a conceptual basis. It also shows that the primitive video signal is scaled to an image with a resolution of 1280×768 through the scaler 122 and that the GUI is also scaled to the same image with a resolution of 1280×768 through the GUI image processor 222.

If the above-described special processing is not performed to the GUI display, i.e. if the same processing (including the scaling) is executed without distinction of the GUI display and the primitive video signal, the quality of the GUI display is deteriorated, in the case explained with reference to FIG. 9 and FIG. 10. The present embodiment is different from this case.

As a second specific example of the “special processing”, processing of mutually changing the features of digital filters (not illustrated) as scalers, which are included in the scaler 122 and the GUI image processor 222, can be considered. Specifically, with respect to the digital filter of the GUI image processor 222, it is possible to weaken the degree of filtering as compared with the digital filter of the scaler 122. According to this, there is a possibility that a folding noise is generated with respect to the GUI display, but it is possible to maintain the original data as long as possible, which allows the GUI display to maintain the preciseness and the fineness.

Alternatively, as a third specific example of the “special processing”, the following processing can be considered. Namely, the GUI display is made not with the primitive video signal (the step S201 in FIG. 12) but as a completely different video signal from the primitive video signal. For example, the primitive video signal except a portion in which the GUI display is to be performed is made, and is scaled independently of the above. With respect to the GUI display, which looks as if it were already scaled is made completely separately. In other words, with respect to the GUI display, it is a method of making the GUI display in advance as a display for which the scaling is unnecessary, i.e. a display which is already enlarged or down-scaled. By constituting in this manner, the GUI display does not have to be scaled, so that crashing the font or the like constituting the GUI display (in the case of down-scaling) and emphasizing the roughness thereof (in the case of enlarging) do not happen.

In the processing described above, it is necessary to remove the portion in which the GUI display is to be performed from the primitive video signal. Thus, if the GUI display is not performed in the portion in which the GUI display is expected to be performed, it is displayed in black (e.g., a black rectangular area is displayed in the screen) or displayed in white (e.g., a white rectangular area is displayed in the screen). This also means that even if the extent of the scaling of the primitive video signal disagrees in size with the GUI made in advance, one portion of the portion in which the GUI is to be displayed is displayed in black or in white. Therefore, in the processing method, it is necessary to accurately consider the extent of the scaling or the like for the primitive video signal and accurately make the GUI, in order not to perform the display in black or in white as described above. The processing is expected to be relatively easily performed without great difficulties.

In any case, as described above, according to the second embodiment having the above-described structure and operation, it is possible to perform the GUI display in high quality.

(Third Embodiment—in the Case of Using an Inverse Function of a Scaling Function)

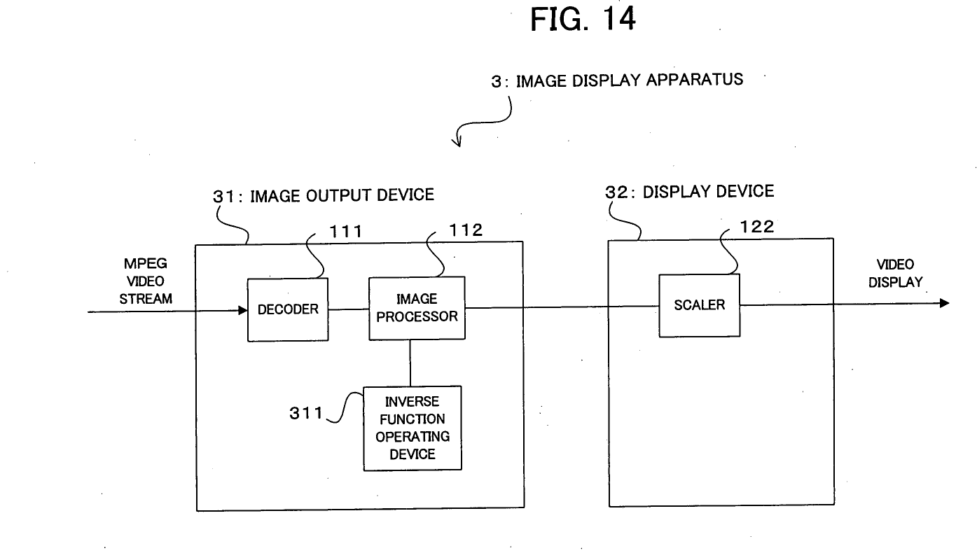

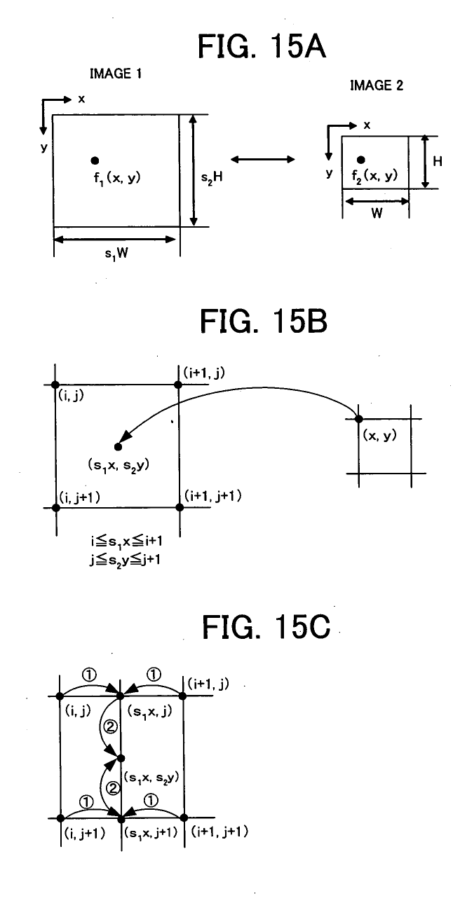

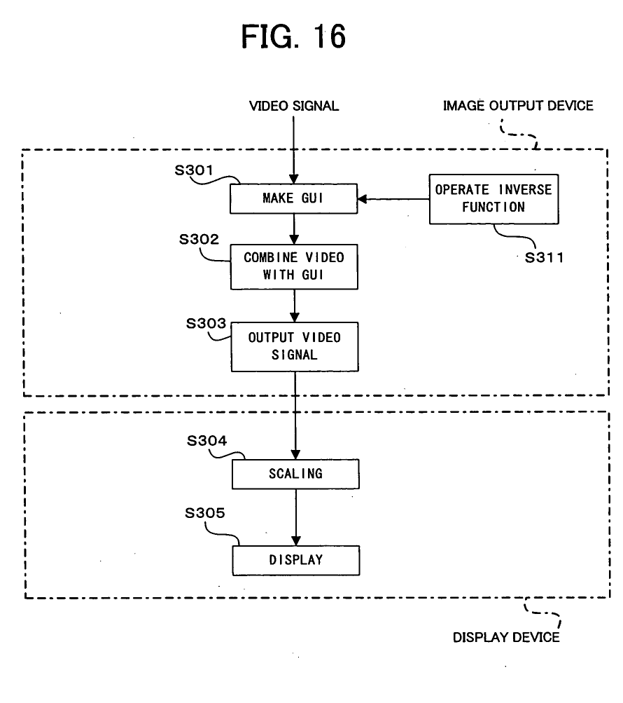

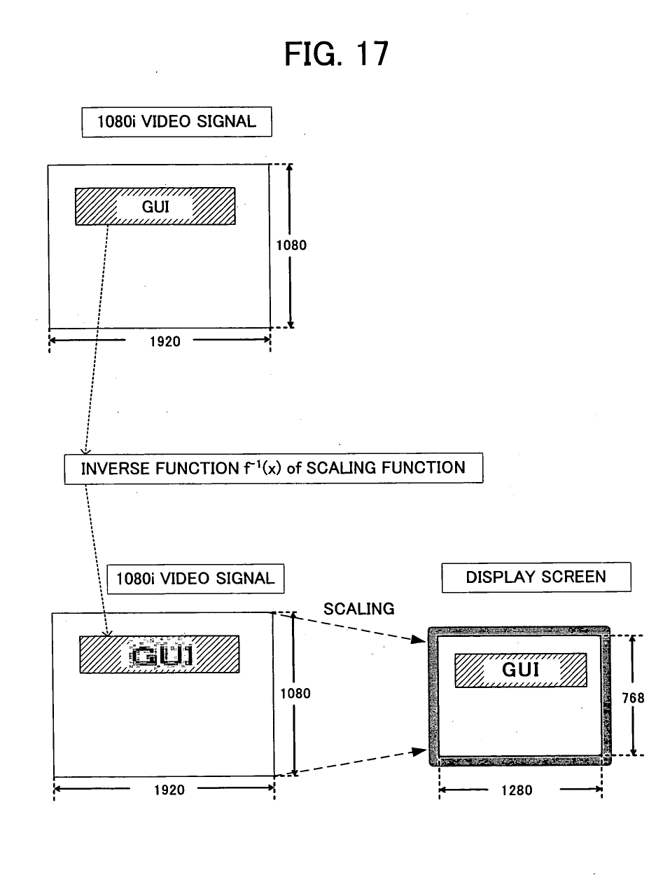

Next, with reference to FIG 0.14 and FIG. 15A to FIG. 15C, the third embodiment associated with the display device of the present invention will be explained. FIG. 14 shows a structure example of an image display apparatus 3 in a third embodiment. FIG. 15A to FIG. 15C show one specific example of the basis of and how to obtain functions to be operated to the GUI or the like on an inverse function operating device 311 and the scaler 122 shown in FIG. 14. FIG. 16 shows the flow of GUI displaying by the image display apparatus 3. FIG. 17 shows one processing in the displaying shown in FIG. 16 on a conceptual basis. With respect to the image display apparatus in the third embodiment, the explanation for the same or overlapping structure as compared with the above-described first embodiment will be omitted or simplified below. The feature in the third embodiment will be mainly explained. In the drawings referred to below, if indicating substantially the same elements of the image display apparatus in the first embodiment, the constitutional elements carry the same reference numerals already used above.

In FIG. 14, as opposed to the above-described image display apparatus 1 in the first embodiment, the image display apparatus 3 is provided with: an image output device 31 including the inverse function operating device 311. The inverse function operating device 311 operates an inverse function of a scaling function on the scaler 122 to the GUI made on the image processor 112 of the image output device 31. On the image display apparatus 3 associated with the third embodiment, both the GUI to which the inverse function is operated and the primitive video signal are transmitted to the display device 32 and scaled by the scaler 122 of the display device 32. Therefore, with respect to the GUI display, it once undergoes the operation of the inverse function and then undergoes the operation of the scaling function, by which an image corresponding to the resolution of the display device 32 is displayed.

The inverse function or the scaling function described above is determined as follows, for example.

As shown in FIG. 15A, it is assumed that an image 1 is scaled to an image 2 (which is down-scaled in this case). Here, the brightness at arbitrary coordinates (x,y) on the image 1 and the image 2 is fᵢ(x,y) and f₂(x,y), and s₁ and s₂ shown in FIG. 15A are scaling factors. It is also assumed that coordinates (s₁x, s₂y) on the image 1 and the coordinates (x,y) on the image 2 have a mapping relationship to each other.

In this case, firstly, (i, j) is set which satisfies the following equations (1) and (2) with respect to the four neighborhood points (i, j), (i+1, j), (i, j+1), and (i+1, j+1) of the point (s₁x, s₂y) (wherein i and j are both integral numbers) (refer to FIG. 15B).
i≦s₁x≦i+1 (1)
j≦s₂y≦j+1 (2)

By using the brightness of the points (i, j) and (i+1, j) out of the four neighborhood points set in this manner and the following equation (3), the brightness of a point (s₁x, j) is calculated by linear interpolation. By using the brightness of the rest points (i, j+1) and (i+1, j+1) and the following equation (4), the brightness of a point (s₁x, j+1) is calculated by linear interpolation (refer to FIG. 15C). Incidentally, arrows with marks \mathring{1} in FIG. 15C conceptually show an image that the linear interpolation is performed by the equations (3) and (4).
f₁(s₁x,j)={f₁(i+1,j)−f₁(i,j)}·(s₁x−i)+f₁(i,j) (3)
f₁(s₁x,j+1)={f₁(i+1,j+1)−f₁(i,j+1)}·(s₁x−i)+f₁(i,j+1) (4)

Then, the brightness of (s₁x, s₂y) is calculated by linear interpolation by the following equation (5) which uses these f₁(s₁x, j) and f₁(s₁x, j+1) (refer to marks \mathring{2} in FIG. 15C). Incidentally, arrows with the marks \mathring{2} in FIG. 15C conceptually show an image that the linear interpolation is performed by the equation (5).
f₁(s₁x,s₂y)={f₁(s₁x,j+1)−f₁(s₁x,j)}·(s₂y−j)+f₁(s₁x,j) (5)

The f₁(s₁x, s₂y) calculated on the image 1 in this manner is regarded as a value of f₂ (x,y) on the image 2 (refer to FIG. 15B). The above operation is performed with respect to all the pixels on the image 2.

The “scaling function” in the above scaling conceivably corresponds to such as shown in the equations (3) to (5) described above. In this case, if the back projection of the above is performed, what is needed is to think of a function including the reciprocals of the scaling factors s₁ and s₂ in the scaling function as factors. Namely, the inverse function of the scaling function is as follows.
f₂((x/s₁),j)={f₂(i+1,j)−f₂(i,j)}·((x/s₁)−i)+f₂(i,j) (3′)
f₂((x/s₁),j+1)={f₂(i+1,j+1)−f₂(i,j+1)}·((x/s₁)−i)+f₂(i,j+1) (4′)
f₂((x/s₁),(y₁s₂))={f₂((x/s₁),j+1)−f₂((x/s₁),j)}·((y₁s₂)−j)+f₂((x/s₁),j) (5′)

On the inverse function operating device 311 in the third embodiment, the inverse functions (3′) to (5′) are once operated to the made GUI. It undergoes the operation of the scaling functions (3) to (5) on the scaler 122. Incidentally, the above-described scaling function and the inverse function thereof are merely one example. Needless to say, various examples are conceivable except the above example.

According to the image display apparatus 3 constructed in this manner, it is operated as shown in FIG. 16 and FIG. 17, and as a result, the following operational effect is obtained. In FIG. 16, at first, the image output device 31 receives the primitive video signal and makes a GUI (step S301 in FIG. 16). With respect to the making of the GUI, after the image output device 31 makes the GUI matching the resolution of the primitive video signal, the inverse function operating device 311 operates the inverse function of the scaling function to the GUI (step S311 in FIG. 16). Then, the image output device 31 combines the GUI to which the inverse function is operated in this manner with the primitive video signal (step S302 in FIG. 16) and transmits the combined video signal to the display device 32 (step S303 in FIG. 16). The display device 32 scales the video signal on the scaler 122 (step S304 in FIG. 16) and then displays an image (step S305 in FIG. 16). Incidentally, FIG. 17 shows the processing in the above-described step S304 as a transition from the upper left to the lower left in FIG. 17 and the processing in the above-described step S304 as a transition from the lower left to the lower right in FIG. 17.

In this case, the GUI is scaled in the step S303, but because it already undergoes the operation of the inverse function before that, it is not simply enlarged nor down-scaled as shown in FIG. 9 and FIG. 10. In other words, qualitatively speaking, the GUI in the third embodiment is once enlarged and then down-scaled, or once down-scaled and then enlarged. Thus, crashing the font or the like constituting the GUI display (in the case of down-scaling) and emphasizing the roughness thereof (in the case of enlarging) do not happen.

As described above, according to the third embodiment having the above-described structure and operation, it is possible to perform the GUI display in high quality.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-205419 filed on Aug. 1, 2003 including the specification, claims, drawings and summary is incorporated herein by reference in its entirety.

1. An image display apparatus comprising:
a display device for displaying an image with a resolution of u×v; and
an image processing device for making second video information for a second image, so as not to exceed the resolution of u×v and according to a difference in resolution of first video information for displaying a first image with a resolution of p×q (wherein at least one of p≠u and q≠v is valid), and for combining the made second video information with the first video information,
said display device extracting the second video information from the first video information, to thereby display the second video image based on the extracted second video information.

2. The image display apparatus according to claim 1, wherein the second image includes a graphic image.

3. An image display apparatus comprising:
a display device for displaying an image with a resolution of u×v; and
a scaling device for performing such a scaling process that primitive video information with a resolution of r×s is converted to video information for display for the resolution of u×v (wherein at least one of r≠u and s≠v is valid),
said scaling device performing the scaling process only once with respect to the primitive video information.

4. The image display apparatus according to claim 3, wherein the primitive video information includes video information of a data broadcast based on a High Definition (HD) standard.

5. An image display apparatus comprising:
a display device for displaying an image with a resolution of u×v;
a scaling device for performing such a scaling process that primitive video information with a resolution of r×s is converted to video information for display for the resolution of u×v (wherein at least one of r≠u and s≠v is valid); and
an image processing device for making graphic video information for displaying a graphic image harmonized with the resolution of r×s and for combining the made graphic video information with the primitive video information,
said scaling device comprising:
a first image processing device for performing an imaging process for the primitive video information including the scaling process; and
a second image processing device for performing an imaging process for the graphic video information which is different from the imaging process for the primitive video information.

6. The image display apparatus according to claim 5, further comprising: a key signal generating device for generating a key signal for identifying at which position of the primitive video signal the graphic video information is combined,
said scaling device using, for image display, any one of (i) video information passed through the first image processing device and (ii) video information passed through the second image processing device, according to the generated key signal.

7. An image display apparatus comprising:
a display device for displaying an image with a resolution of u×v;
a scaling device for performing such a scaling process that primitive video information with a resolution of r×s is converted to video information for display for the resolution of u×v (wherein at least one of r≠u and s≠v is valid); and
an image processing device for making graphic video information for displaying a graphic image harmonized with the resolution of u×v and for combining the made graphic video information with the video information for display.

8. An image display apparatus comprising:
a display device for displaying an image with a resolution of u×v;
a scaling device for performing such a scaling process that primitive video information with a resolution of r×s is converted to video information for display for the resolution of u×v (wherein at least one of r≠u and s≠v is valid);
an image processing device for making graphic video information for displaying a graphic image harmonized with the resolution of r×s; and
an inverse scaling device for performing an inverse process of the scaling process with respect to the graphic video information, to thereby make inverse-scaled video information,
said scaling device performing the scaling process with respect to both of the primitive video information and the inverse-scaled video information.
